(19) United States
(12) Patent Application Publication
(10) Pub. No.: US 2014/0096509 A1
(43) Pub. Date: Apr. 10, 2014

(54) Geared Turbofan Engine With Increased Bypass Ratio and Compressor Ratio ...

(71) Applicant: UNITED TECHNOLOGIES CORPORATION, Hartford, CT (US)

(72) Inventor: Karl L. Hasel, Manchester, CT (US)

(73) Assignee: UNITED TECHNOLOGIES CORPORATION, Hartford, CT (US)

(21) Appl. No.: 13/716,253

(22) Filed: Dec. 17, 2012

Related U.S. Application Data
(60) Provisional application No. 61/710,465, filed on Oct. 5, 2012.

(51) Int. Cl. F02K 3/075

(52) U.S. Cl. CPC F02K 3/075
USPC 60/226.3

(57) ABSTRACT

A gas turbine engine is typically comprised of a fan stage, multiple compressor stages, and multiple turbine stages. These stages are made up of alternating rotating blade rows and static vane rows. The total number of blades and vanes is the airfoil count. An overall pressure ratio is greater than 30. A bypass ratio is greater than 8. A stage ratio is the product of the bypass ratio and the overall pressure ratio divided by the number of stages. An airfoil ratio is that product divided by the airfoil count. The stage ratio is greater than or equal to 22 and/or the airfoil ratio is greater than or equal to 0.12.

### CROSS-REFERENCE TO RELATED APPLICATION

This application claims priority to U.S. Provisional Application No. 61/710,465, which was filed Oct. 5, 2012.

### BACKGROUND OF THE INVENTION

This application relates to a geared turbofan engine in which a ratio of a multiple of an overall pressure ratio and a bypass ratio divided by either the total number of airfoils or the total number of stages across the engine is significantly higher than in the prior art.

Gas turbine engines are known and, typically, include a fan delivering air into a bypass duct and into a compressor. The fan also delivers air into a bypass duct to serve as propulsion for an aircraft carrying an engine. Air in the compressor passes into a combustion section where it is mixed with fuel and ignited. Products of combustion pass downstream over turbine rotors driving them to rotate. The turbine rotors in turn drive compressor and fan rotors. In the prior art, there may be any number of fan, compressor and turbine rotor stages. Further, each of the rotor stages carries a plurality of blades and there are typically static vanes positioned intermediate the stages at each of the fan, compressor and turbine sections. Both the blades and vanes have airfoils. Thus, there is a total number of stages and a total number of airfoils across any gas turbine engine.

Historically, a lower pressure turbine would drive a lower pressure compressor and the fan at a common speed. In such traditional direct drive turbofans, there would be a relatively high number of stages and airfoils compared to a product of an overall pressure ratio achieved across the fan and the two compressor components, and the bypass ratio, or volume of air delivered into the bypass duct, compared to the volume delivered to the compressor.

More recently, it has been proposed to incorporate a gear reduction between the fan and the lower pressure turbine.

### SUMMARY OF THE INVENTION

In a featured embodiment, a gas turbine engine has a fan rotor, a first compressor rotor and a second compressor rotor, a first turbine rotor and a second turbine rotor, The first compressor rotor is configured for operating at a lower pressure than the second pressure rotor. The second turbine rotor is configured for operating at a higher pressure than the first turbine rotor. The first turbine rotor is configured to drive the first compressor rotor. The second turbine rotor is configured to drive the second compressor rotor. The first turbine rotor is also configured to drive the fan rotor through a gear reduction. There is a first number of blades associated with each of the fan rotors. The first and second compressor rotors and the first and second turbine rotors, and a second number of static vane members are positioned between stages of each of the fan rotor, the first and second compressor rotors and the first and second turbine rotors. The sum of the number of the blades and vanes is a total airfoil count. There is a number of the stages in the fan rotor, the first and second compressor rotors and the first and second turbine rotors. There is an overall pressure ratio from an inlet end of the fan rotor to an outlet end of the second compressor rotor with the overall pressure ratio being greater than 30 at 35,000 feet and operating at a 0.80 MN cruise flight condition. The fan rotor delivers air into the first compressor rotor and further into a bypass duct as bypass propulsion air. A bypass ratio is defined as the quantity of air delivering into the bypass duct divided by the quantity of air delivered into the first compressor rotor. The bypass ratio is greater than 8. A stage ratio of the product of the bypass ratio and the overall pressure ratio is divided, and that product is divided by the number of stages, with the stage ratio being greater than or equal to 22. Or, the product is divided by the total airfoil count to gain an airfoil ratio, with the airfoil ratio being greater than or equal to 0.12.

In another embodiment according to the previous embodiment, both the first and second ratios are greater than or equal to the quantities.

In another embodiment according to any of the previous embodiments, the stage ratio is greater than 22.

In another embodiment according to any of the previous embodiments, the airfoil ratio is greater than 0.15.

In another embodiment according to any of the previous embodiments, the stage ratio is less than 40.

In another embodiment according to any of the previous embodiments, the airfoil ratio is less than 0.25.

In another embodiment according to any of the previous embodiments, the gear reduction has a gear ratio of between 2.4 and 4.2.

In another embodiment according to any of the previous embodiments, the bypass ratio is greater than 10.

In another embodiment according to any of the previous embodiments, the overall compression ratio is achieved with a pressure ratio across the fan that is less than or equal to about 1.45.

These and other features may be best understood from the following drawings and specification.

### BRIEF DESCRIPTION OF THE DRAWINGS

FIG. 1 schematically shows a gas turbine engine.

FIG. 2 is a plot showing a quantity for gear turbofans as modified by Applicant compared to the same quantity for direct drive turbofans and across a range of compression ratios.

FIG. 3 is a plot showing a second quantity for gear turbofans as modified by Applicant compared to the same quantity for direct drive turbofans and across a range of compression ratios.

### DETAILED DESCRIPTION

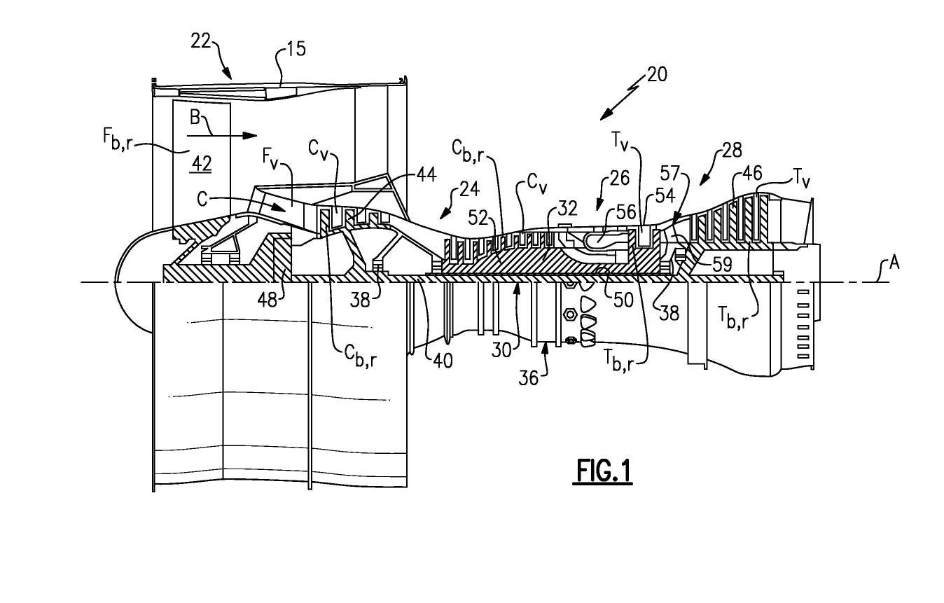

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines including three-spool architectures.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that interconnects a fan 42, a low pressure compressor 44 and a low pressure turbine 46. The inner shaft 40 is connected to the fan 42 through a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path. The turbines 46, 54 rotationally drive the respective low speed spool 30 and high speed spool 32 in response to the expansion.

The engine 20 in one example is a high-bypass geared aircraft engine. In a further example, the engine 20 bypass ratio is greater than about six (6), with an example embodiment being greater than ten (10), the geared architecture 48 is an epicyclic gear train, such as a planetary gear system or other gear system, with a gear reduction ratio of greater than about 2.3 and the low pressure turbine 46 has a pressure ratio that is greater than about 5. In one disclosed embodiment, the engine 20 bypass ratio is greater than about ten (10:1), the fan diameter is significantly larger than that of the low pressure compressor 44, and the low pressure turbine 46 has a pressure ratio that is greater than about 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.5:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption ('TSFC')”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second.

As shown in FIG. 1, the fan rotor carries a plurality of fan blades and a single rotor stage in the illustrated embodiment, identified by F_{b,r}. Further, there is a row of fan vanes Fᵥ. There are a plurality of vanes and blades in the row Fᵥ. In the compressor section 24 there are a number of rows having vanes Cᵥ where each of these have a plurality of vanes. The compressor section also has a plurality of rotor stages, each carrying a plurality of blades identified at C_{b,r}. In the turbine section there are turbine rotors with stages carrying turbine blades T_{b/r}, and there are turbine vanes T. In each of the stages there are a plurality of vanes. The drawings identify some of the stages and vane rows. A worker of ordinary skill in this art would recognize where each of these components are in schematic FIG. 1.

Collectively, the total number of airfoils could be counted across a fan section 22, compressor section 24 and turbine section 28. Similarly, the number of stages can be counted collectively across the fan 22, compressor 24 and turbine 26.

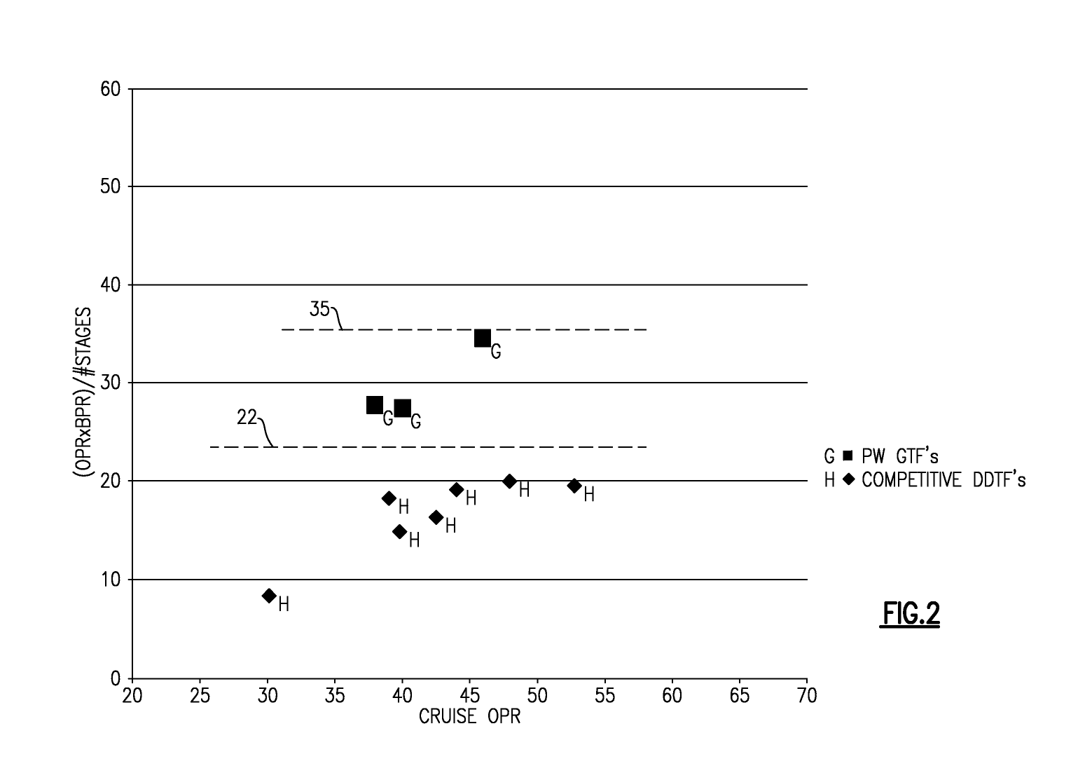

As shown in FIG. 2, a quantity can be defined by the product of turbofans having an overall pressure ratio (OPR) provided by the fan and compressor sections multiplied by the bypass ratio (BPR), with that product divided by the number of stages. That quantity is graphed compared to the overall pressure ratio at cruise for both direct drive turbofans (H) and applicant's geared turbofans (G). The direct drive turbofans have a ratio that was at most approximately 20 across a range of overall pressure ratios at cruise altitude.

On the other hand, Applicant's engines are shown at G. Applicant has increased the bypass ratio (BPR) and significantly decreased the number of stages. As such, Applicant is able to achieve quantities equal to, or above 22 for the BPR ratio, even at overall pressure ratios (OPRs) where the direct drive turbofan H were far below 22. In fact, Applicant's engines may achieve products as high as 35 and, perhaps, as high as 40.

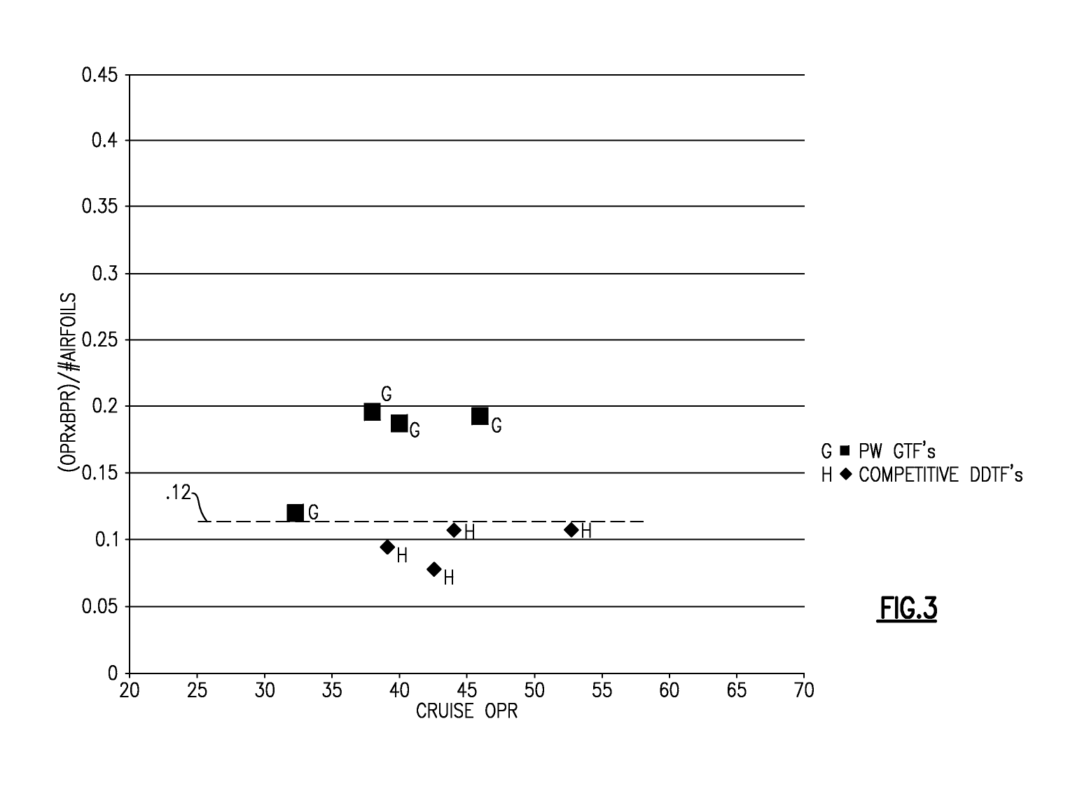

Similarly, as shown in FIG. 3, the quantity of a product of OPR and BPR divided by the number of airfoils in direct drive engines H has typically been below 0.12 across a range of overall pressure ratios. On the other hand, Applicant's disclosed embodiment reduces the number of airfoils, increases the bypass ratio (BPR) and overall pressure ratio (OPR) and achieves quantities equal to or over 0.12, equal to or over 0.15, approaching and even passing 0.2. It is believed applicant can achieve quantities as high as 0.25. Again, these improvements have been achieved by increasing the bypass ratio and overall pressure ratio while significantly decreasing the number of airfoils.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
a fan rotor, a first compressor rotor and a second compressor rotor, a first turbine rotor and a second turbine rotor, said first compressor rotor configured for operating at a lower pressure than said second compressor rotor and said second turbine rotor configured for operating at a higher pressure than said first turbine rotor, said first turbine rotor configured to drive said first compressor rotor, and said second turbine rotor configured to drive said second compressor rotor and said first turbine rotor also configured to drive said fan rotor through a gear reduction;
wherein a first number is defined as the total of blades collectively associated with each of said fan rotor, said first and second compressor rotors and said first and second turbine rotors,
wherein a second number is defined as the total of static vane members collectively associated with each of said fan rotor, said first and second compressor rotors and said first and second turbine rotors,
wherein a third number is defined as a sum of the first number and the second number;
wherein a fourth number is defined as the total of stages collectively associated with each of the fan rotor, the first and second compressor rotors and the first and second turbine rotors;
wherein an overall pressure ratio from an inlet end of said fan rotor to an outlet end of said second compressor rotor is configured to be greater than 30 at 35,000 feet and operating at a 0.80 MN cruise flight condition;
wherein said fan rotor is configured to deliver air into:
said first compressor rotor; and
a bypass duct as bypass propulsion air,
wherein a bypass ratio is defined as the quantity of air delivered into the bypass duct divided by the quantity of air delivered into the first compressor rotor,
wherein the bypass ratio is greater than about 8.0;
wherein a product is defined by the bypass ratio multiplied by the overall pressure ratio, and
wherein a stage ratio is defined as said product divided by said fourth number
wherein an airfoil ratio is defined as said product divided by said third number; and
wherein:
said airfoil ratio is greater than or equal to 0.12; or
said stage ratio is greater than or equal to 22.

2. (canceled)

3. The gas turbine engine as set forth in claim 1, wherein said stage ratio is greater than 22.

4. The gas turbine engine as set forth in claim 1, wherein said airfoil ratio is greater than 0.15.

5. The gas turbine engine as set forth in claim 1, wherein said stage ratio is less than 40.

6. The gas turbine engine as set forth in claim 1, wherein said airfoil ratio is less than 0.25.

7. The gas turbine engine as set forth in claim 1, wherein said gear reduction having a gear ratio of between 2.4 and 4.2.

8. The gas turbine engine as set forth in claim 1, wherein said bypass ratio is greater than 10.

9. The gas turbine engine as set forth in claim 1, wherein said overall compression ratio is achieved with a pressure ratio across said fan being less than or equal to about 1.45.

10. The gas turbine engine as set forth in claim 1, wherein said stage ratio being greater than or equal to 22 and said airfoil ratio being greater than or equal to 0.12.

11. A gas turbine engine comprising:
a fan rotor, a first compressor rotor and a second compressor rotor, a first turbine rotor and a second turbine rotor, said first compressor rotor configured for operating at a lower pressure than said second compressor rotor and said second turbine rotor configured for operating at a higher pressure than said first turbine rotor, said first turbine rotor configured to drive said first compressor rotor, and said second turbine rotor configured to drive said second compressor rotor and said first turbine rotor also configured to drive said fan rotor through a gear reduction;
wherein a first number is defined as the total of blades collectively associated with each of said fan rotor, said first and second compressor rotors and said first and second turbine rotors;
wherein a second number of static vane members collectively associated with each of said fan rotor, said first and second compressor rotors and said first and second turbine rotors;
wherein a third number is defined as a sum of the first number and the second number;
wherein a fourth number is defined as the total of stages collectively associated with each of the fan rotor, the first and second compressor rotors and the first and second turbine rotors;
wherein an overall pressure ratio from an inlet end of said fan rotor to an outlet end of said second compressor rotor is configured to be greater than 30 at 35,000 feet and operating at a 0.80 MN cruise flight condition;
wherein said fan rotor is configured to deliver air into said first compressor rotor;
a bypass duct as bypass propulsion air;
wherein a bypass ratio is defined as the quantity of air delivered into the bypass duct divided by the quantity of air delivered into the first compressor rotor;
wherein the bypass ratio is greater than about 8.0;
wherein a product is defined by the bypass ratio multiplied by the overall pressure ratio;
wherein a stage ratio is defined as said product divided by said fourth number;
wherein an airfoil ratio is defined as said product divided by said third number;
wherein said airfoil ratio being greater than or equal to 0.12 and said stage ratio being greater than or equal to 22;
wherein said stage ratio is less than 40;
wherein said airfoil ratio is less than 0.25; and
wherein said gear reduction having a gear ratio of between 2.4 and 4.2.

12. The gas turbine engine as set forth in claim 11, wherein said stage ratio is greater than 22.

13. The gas turbine engine as set forth in claim 11, wherein said airfoil ratio is greater than 0.15.

14. The gas turbine engine as set forth in claim 11, wherein said bypass ratio is greater than 10.
